(19) United States
(12) Patent Application Publication
(10) Pub. No.: US 2024/0297974 A1
(43) Pub. Date: Sep. 5, 2024

(54) METHOD, APPARATUS, ELECTORNIC DEVICE, AND STORAGE MEDIUM FOR VIDEO IMAGE PROCESSING

(71) Applicant: Beijing Bytedance Network Technology Co., Ltd., Beijing (CN)

(72) Inventor: Tao Zhang, Beijing (CN)

(21) Appl. No.: 18/570,951

(22) PCT Filed: Sep. 30, 2022
(86) PCT No.: PCT/CN2022/123079

§ 371 Date: Dec. 15, 2023

(30) Foreign Application Priority Data
Oct. 29, 2021 (CN) 202111272959.7

(51) Int. Cl. H04N 13/279; G06T 7/246; G06T 7/50; G06V 10/44

(52) U.S. Cl. CPC H04N 13/279; G06T 7/246; G06T 7/50; G06V 10/44

(57) ABSTRACT

Embodiments of the disclosure provide a method, apparatus, electronic device, and storage medium for video image processing. The method includes: determining a target depth view of a plurality of video frames of a target video, and determining a split line depth value of at least one depth split line corresponding to the target video based on the target depth view; for the target depth view, determining a target depth split line corresponding to a current pixel point of a current target depth view, and determining a target pixel value of the current pixel point based on a pixel depth value of the current pixel point and a split line depth value of the target depth split line; and determining a three-dimensional displaying video frame of the plurality of video frames of the target video based on target pixel values of a plurality of pixels in the target depth view.

### CROSS REFERENCE

Embodiments of the present disclosure claims priority to Chinese Patent Application No. 202111272959.7 filed on Oct. 29, 2021, and entitled “METHOD, APPARATUS, ELECTRONIC DEVICE, AND STORAGE MEDIUM FOR VIDEO IMAGE PROCESSING”.

### FIELD

Example embodiments of the present disclosure generally relate to the field of image processing, for example, to a method, apparatus, electronic device, and storage medium for video image processing.

### BACKGROUND

Three-dimension (3-Dimension, 3D) effects, which can give users realistic 3D visual effects, are currently of great concern, to enable users to have an immersive experience when viewing videos, thus improving users' viewing experience.

In the related technology, the implementation of 3D effects mainly relies on 3D effects devices, for example, Virtual Reality (VR), and Augmented Reality (AR) glasses, which can implement better 3D visual effects. However, there are problems of higher cost and limited scenarios, for example, it can not be implemented on mobile terminals or Personal Computer (PC) terminals.

### SUMMARY

The present disclosure provides a method, apparatus, electronic device, and storage medium for video image processing to implement a technical effect of causing an image to perform a three-dimensional display without using a three-dimensional display device.

In a first aspect, embodiments of the present disclosure provide a method of video image processing, comprising:
determining a target depth view of a plurality of video frames of a target video, and determining a split line depth value of at least one depth split line corresponding to the target video based on the target depth view;
for the target depth view, determining a target depth split line corresponding to a current pixel point of a current target depth view, and determining a target pixel value of the current pixel point based on a pixel depth value of the current pixel point and a split line depth value of the target depth split line; and
determining a three-dimensional displaying video frame of the plurality of video frames of the target video based on target pixel values of a plurality of pixels in the target depth view.

In a second aspect, embodiments of the present disclosure also provide an apparatus for video image processing, comprising:
a split line determination module configured to determine a target depth view of a plurality of video frames of a target video, and determine a split line depth value of at least one depth split line corresponding to the target video based on the target depth view;
a pixel value determination module configured to, for the target depth view, determine a target depth split line corresponding to a current pixel point of a current target depth view, and determine a target pixel value of the current pixel point based on a pixel depth value of the current pixel point and a split line depth value of the target depth split line; and
a video displaying module configured to determine a three-dimensional displaying video frame of the plurality of video frames of the target video based on target pixel values of a plurality of pixels in the target depth view.

In a third aspect, embodiments of the present disclosure also provide an electronic device, comprising:
a processor; and
a storage apparatus storing a program,
wherein the program, when executed by the processor, causes the processor to perform the method of video image processing based on any of embodiments of the present disclosure.

In a fourth aspect, embodiments of the present disclosure further provide a storage medium comprising computer-executable instructions, the computer-executable instructions, when executed by a computer processor, performing the method of video image processing based on any of embodiments of the present disclosure.

### BRIEF DESCRIPTION OF THE DRAWINGS

In conjunction with the accompanying drawings and with reference to the following detailed description, the above and other features, advantages, and aspects of the various embodiments of the present disclosure will become more apparent. Throughout the accompanying drawings, the same or similar reference numerals represent the same or similar elements. It should be understood that the accompanying drawings are schematic in nature and that the originals and elements are not necessarily drawn in accordance with scale.

FIG. 1 shows a schematic flowchart of a method of video image processing provided by embodiment 1 of the present disclosure;

FIG. 2 shows a schematic diagram of at least one depth split line provided by embodiments of the present disclosure;

FIG. 3 shows a schematic flowchart of a method of video image processing provided by embodiment 2 of the present disclosure;

FIG. 4 shows a video frame and a to-be-processed depth diagram corresponding to the video frame provided by embodiments of the present disclosure;

FIG. 5 shows a video frame and a to-be-processed mask map corresponding to the video frame provided by embodiments of the present disclosure;

FIG. 6 shows a schematic flowchart of a method of video image processing provided by embodiment 3 of the present disclosure;

FIG. 7 shows a schematic diagram of a three-dimensional video frame provided by embodiments of the present disclosure;

FIG. 8 shows a structural schematic diagram of an apparatus for video image processing provided by embodiment 4 of the present disclosure;

FIG. 9 shows a structural schematic diagram of an electronic device provided by embodiment 5 of the present disclosure.

### DETAILED DESCRIPTION

Embodiments of the present disclosure will be described below with reference to the accompanying drawings. Although some embodiments of the present disclosure are shown in the accompanying drawings, it should be understood that the present disclosure can be implemented in various forms, and these embodiments are provided for a more thorough and complete understanding of the present disclosure. It should be understood that the drawings and embodiments of the present disclosure are intended to be exemplary only.

It should be understood that the various steps documented in the method embodiments of the present disclosure may be performed in a different order, and/or in parallel. In addition, the method embodiments may comprise additional steps and/or omit performing the illustrated steps. The scope of the present disclosure is not limited in this regard.

As used herein, the term “comprises” and its variations are open-ended, i.e., “comprising, but not limited to”. The term “based on” is “based at least partially on”. The term “one embodiment” represents “at least one embodiment”; the term “another embodiment” represents “at least one additional embodiment”; the term “some embodiments” represents “at least some embodiments”.

Related definitions of other terms will be given in the description below.

It should be noted that references to the concepts of “first”, “second” and the like in the present disclosure are only used to distinguish different apparatuses, modules, or units, and are not intended to limit the order or interdependence of the functions performed by these apparatuses, modules, or units.

It should be noted that references to the qualifications “one” and “a plurality of” in the present disclosure are schematic rather than limiting. It should be understood by those skilled in the art that the term “one or more” should be understood unless the context clearly indicates otherwise.

The names of messages or information interacting between a plurality of apparatuses in embodiments of the present disclosure are used for illustrative purposes only and are not intended to place limitations on the scope of those messages or information.

### Embodiment 1

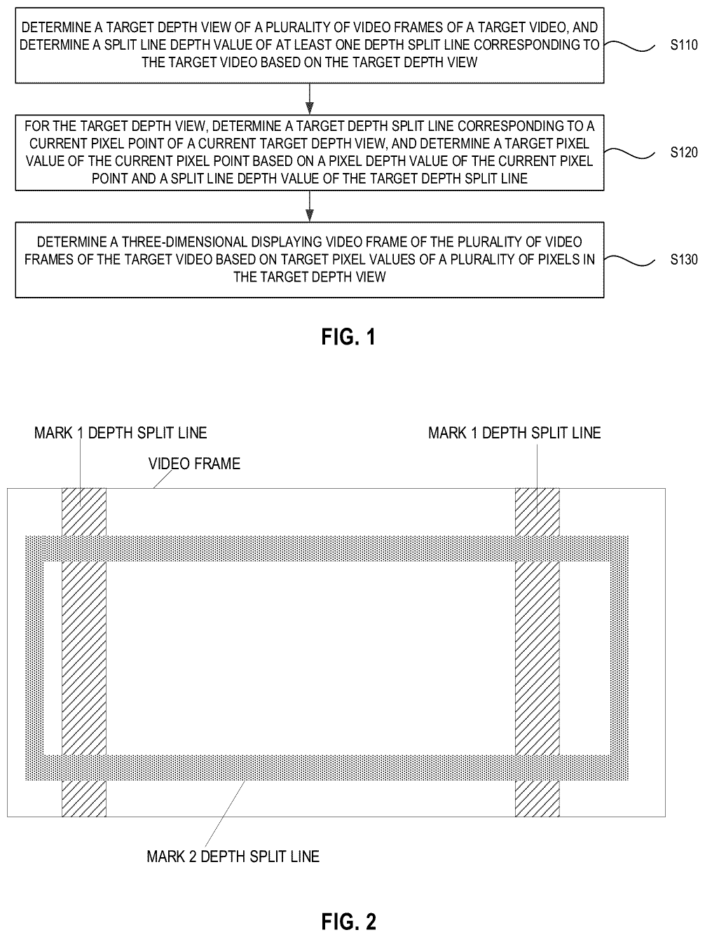

FIG. 1 shows a schematic flowchart of a method of video image processing provided by embodiment 1 of the present disclosure. Embodiments of the present disclosure are applicable when, in a variety of video display scenarios supported by the Internet, by processing respective pixel points of a video frame to obtain a three-dimensional display effect. The method may be performed by an apparatus for video image processing, which may be implemented in the form of software and/or hardware, and optionally by an electronic device, which may be a mobile terminal, a PC, or a server, etc. The method provided herein may be performed by a server, a client, or a combination of a client and a server.

As shown in FIG. 1, the method comprises:

S110. Determine a target depth view of a plurality of video frames of a target video, and determine a split line depth value of at least one depth split line corresponding to the target video based on the target depth view.

In the embodiment, the to-be-processed current video is determined as a target video. The target video comprises a plurality of video frames. A target depth view can be determined for respective video frame separately. Generally, the video frames can be directly converted to the corresponding depth view, but the depth information in the depth view is mostly an absolute depth information. In order to enable the depth of the front and back video frames to match, the depth view of the whole video frame after the absolute depth information is aligned can be determined as the target depth view. The depth split line may be a front-background split line, i.e., a split line for distinguishing a foreground from a background. The number of at least one depth split line may be one or more. The user may mark a plurality of depth split lines based on actual needs, and then determine depth values of the plurality of depth split lines based on the target depth views of the plurality of video frames. The depth value of the depth split lines is determined as the split line depth value.

In an embodiment, a plurality of video frames in a target video are extracted and processed to obtain a target depth view of the plurality of video frames. The pre-marked depth split lines may be processed based on the depth view of the plurality of video frames to determine split line depth values of the plurality of depth split lines.

In the present embodiment, before determining a target depth view of a plurality of video frames of a target video, the method further comprises: receiving the target video; setting at least one depth split line corresponding to the target video, and determining a position and width of the at least one depth split line in the target video based on a display parameter of the target video.

Generally, the computing power of the server is much larger than the computing power of the display device, e.g., the display device may be a mobile terminal, a PC, and so on. Therefore, it is possible to determine the target depth view of a plurality of video frames in the target video based on the server, and then determine the three-dimensional displaying video frames corresponding to the plurality of video frames. The three-dimensional displaying video frame can also be understood as a three-dimensional effect video frame. That is, the target video is sent to the server, and the server processes respective video frame to obtain a three-dimensional displaying video corresponding to the target video. Based on the marking tool, at least one line is marked on the target video, which may or may not be perpendicular to the edge line of the display device. The position can be understood as the location of the depth line in the target video. For example, referring to mark 1 in FIG. 2, the position of the depth split line is the position of the video edge, and the width of the depth split line matches the display parameters of the target video, and optionally the width of the split line is one-twentieth of the length of the long edge.

In an embodiment, a to-be-processed video of the server is determined as a target video. The target video is marked with a depth line based on the requirements to obtain at least one depth split line. Meanwhile, when marking the depth split line, the width and position of the depth split line can be determined based on the display information of the target video. If the number of depth split lines is one, the depth split line can be marked at any position; if the number of depth split lines is two, the depth split line can be perpendicular to the long side of the display parameter when the video is playing normally in order to comply with the user's viewing habits. The width of the depth split line is generally one-twentieth of the width of the long side. Certainly, the depth split line can also be a split line inside the target video, around the target video, referring to FIG. 2 for a circular depth split line with the mark 2.

It should be noted that mark 1 and mark 2 are used selectively, and there is generally no case in which both mark 1 and mark 2 correspond to the same target video.

In the present embodiment, the determining a width of a position of the at least one depth split line comprises: determining a position and width of the at least one depth split line in the target video based on a display parameter of the target video.

In the present embodiment, the display parameter is a display length and a display width of the target video when the target video is displayed on the display interface. The position may be a relative position of the depth split line from an edge line of the target video. The width may be a width value of the depth split line corresponding to a display length in the target display video.

In the present embodiment, the advantage of setting the at least one depth split line is that the split line depth value of the at least one depth split line can be determined, and the target pixel value of respective video frames of the target video frame can be determined based on the split line depth value to obtain a technical effect of a three-dimensional displaying video frame.

S120. For the target depth view, determine a target depth split line corresponding to a current pixel point of a current target depth view, and determine a target pixel value of the current pixel point based on a pixel depth value of the current pixel point and a split line depth value of the target depth split line.

In the present embodiment, the target video comprises a plurality of video frames, and respective video frame has a target depth view. Respective pixels in the target depth view may be processed, and the pixel that is currently to be processed or is being processed may be determined as the current pixel. A depth split line corresponding to the target video comprises at least one depth split line, and the depth split line at which the current pixel point is located may be determined as the target depth split line. The pixel depth value may be a depth value of the current pixel point in the target depth view. The split line depth value may be a predetermined split line depth value. The split line depth value is used to determine a pixel value of a pixel point in a video frame, and thus determine a corresponding 3D display effect. The depth split line has a certain width, and correspondingly the split line comprises a plurality of pixels, and in this case the depth values of the plurality of pixels are the same. Based on the relationship between the pixel depth value and the split line depth value, the target pixel value of the current pixel point can be determined.

In an embodiment, for the target depth view of respective video frame, a depth split line corresponding to respective pixel point in the current video frame can be determined, and a correspondence between the depth value of the current pixel point and the depth value of the respective split line can be determined. Based on the correspondence, target pixel values of a plurality of pixel points may be determined.

S130. Determine a three-dimensional displaying video frame of the plurality of video frames of the target video based on target pixel values of a plurality of pixels in the target depth view.

In the present embodiment, the target pixel value may be the RGB value of the pixel point, the pixel value after adjusting the corresponding pixel point of the video frame. The three-dimensional displaying video frame may be a video frame that appears to the user to be a three-dimensional effect.

In an embodiment, a target pixel value of the plurality of pixel points is obtained based on the pixel value of respective pixel points in the plurality of video frames redetermined by S120. Based on the target pixel value of respective pixel point in the plurality of video frames, a three-dimensional displaying video frame corresponding to the plurality of video frames is determined. A target three-dimensional video corresponding to the target video may be determined based on the plurality of three-dimensional displaying video frames.

It should be noted that the target three-dimensional video appears to be a three-dimensional display from a visual perspective.

The present disclosure obtains at least one depth split line corresponding to the target video by processing a target depth view of a plurality of video frames in the target video. The depth split line is determined as a front background split line of the plurality of video frames in the target video. Based on the at least one depth split line, target display information of respective pixels in the video frames is determined. Based on the target display information, three-dimensional displaying video frame corresponding to the video frame is obtained, which solves the problem of higher cost and poorer universality of three-dimensional displaying when three-dimensional displaying is required in the related technology with the aid of three-dimensional displaying equipment. Implementing the condition that under the condition of without using a three-dimensional displaying device, only processing respective pixel point in the video frame based on at least one pre-determined depth split line to obtain a three-dimensional displaying video frame of the corresponding video frame, which improves the convenience of the three-dimensional displaying as well as the universality of the technical effect.

### Embodiment 2

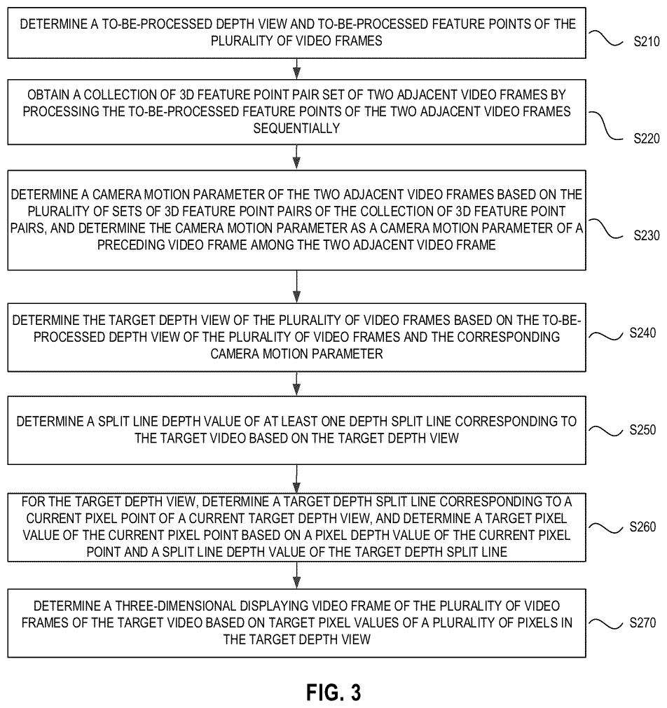

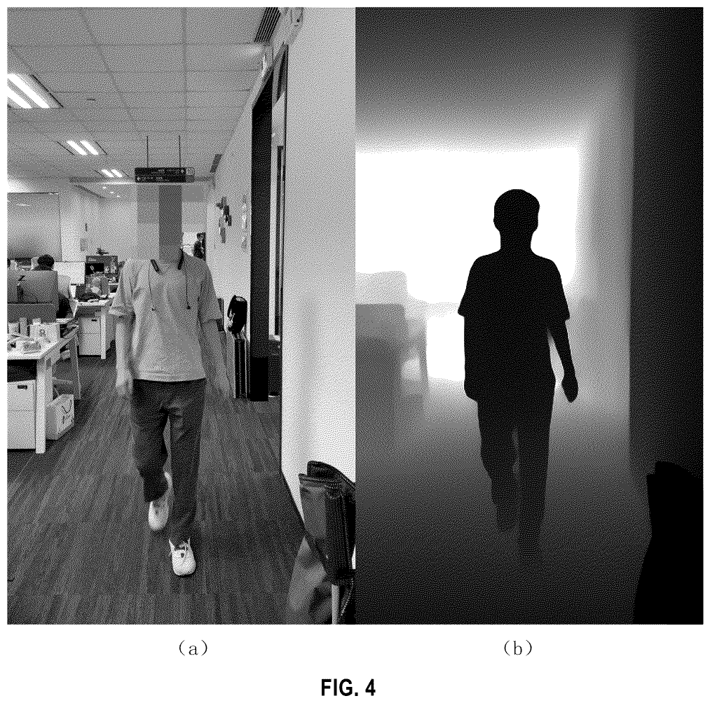

FIG. 3 shows a schematic flowchart of a method of video image processing provided by embodiment 2 of the present disclosure. On the basis of the foregoing embodiments, the target depth view of a plurality of video frames in a determining target video can be altered, and its detailed description can be found in the description of the present embodiments. Herein, the same or corresponding technical terms as the above embodiments will not be repeated herein.

As shown in FIG. 3, the method comprises:

S210. Determine a to-be-processed depth view and to-be-processed feature points of the plurality of video frames.

In the present embodiment, a directly converted depth view of the video frame is determined as the to-be-processed depth view. The to-be-processed feature point may be a feature point of a very stable local feature in the video frame.

In an embodiment, a corresponding depth view processing algorithm may be adopted to convert a plurality of video frames into a to be-processed depth view. At the same time, a feature point collection algorithm may be adopted to determine the to-be-processed feature points in the plurality of video frames.

In embodiments of the present disclosure, determining a to-be-processed depth view and to-be-processed feature points of the plurality of video frames comprises: obtaining the to-be-processed depth view of the plurality of video frames by performing a depth estimation on the plurality of video frames; and determining the to-be-processed feature points of the plurality of video frames by processing the plurality of video frames based on a feature point detection algorithm.

In the present embodiment, the depth value of respective pixel point in the to-be-processed depth view characterizes the distance value of respective pixel point in the video frame relative to the camera imaging plane. That is, the to-be-processed depth view is a schematic diagram composed based on the distance of respective pixel point from the plane of the camera device. Optionally, objects that are farther away from the camera device are represented by a darker color. Referring to FIG. 4, the video frame may be FIG. 4(a), the corresponding depth view of the video frame is 4 (b), i.e., FIG. 4(b) is a simple depth view, wherein the darkness of the color characterizes the proximity to the camera device, with a darker color indicating a greater distance from the camera, and a lighter color indicating a greater proximity to the camera.

While determining the to-be-processed depth view, the to-be-processed feature points in a plurality of video frames can be determined. Optionally, a scale mvanant feature transform (SIFI) feature point detection algorithm can be adopted to determine the respective to-be-processed feature points in respective video frame. The SIFI feature point detection algorithm has the characteristic of being invariant to rotation, scale scaling, brightness changes, etc., and is a very stable local feature that can be determined as a unique characterization of a small local area in a video frame. It can be understood that the feature point detection algorithm can be adopted to determine the to-be-processed feature points in a video frame.

S220. Obtain a collection of 3D feature point pair set of two adjacent video frames by processing the to-be-processed feature points of the two adjacent video frames sequentially.

In the present embodiment, a plurality of groups of feature point pairs are comprised in the collection of 3D feature point pairs. Each set of feature point pairs comprises two feature points, which are obtained by processing two adjacent video frames. For example, video frame 1 and video frame 2 are adjacent video frames, the to-be-processed feature points in video frame 1 and video frame 2 can be determined separately. It is determined which of the to-be-processed feature points in video frame 1 and which of the to-be-processed feature points in video frame 2 are relative to each other, and the two feature points that are relative to each other are determined as a feature point pair. It should be noted that the feature point pairs may be two-dimensional feature point pairs, and the two-dimensional feature point pairs can be processed to obtain 3D feature point pairs.

Optionally, obtaining a collection of 3D feature point pairs of two adjacent video frames by processing the to-be-processed feature points of the two adjacent video frames sequentially comprises: obtaining at least one set of 2D feature point pairs associated with the two adjacent video frames by matching the to-be-processed feature points of the two adjacent video frames sequentially based on a feature point matching algorithm; obtaining an original 3D point cloud corresponding to a to-be-processed depth view and at least one set of 3D feature point pair corresponding to the at least one set of 2D feature point pair, by performing a 3D point cloud reconstruction to the to-be-processed depth view of the two adjacent video frames; and determining the collection of 3D feature point pairs of the two adjacent video frames based on the at least one set of 3D feature point pairs.

In the present embodiment, feature point pairs that match in two adjacent video frames may be determined as 2D feature point pairs. The number of 2D feature point pairs may be 8 groups. The number of at least one set of 2D feature point pairs corresponds to the number of feature point pairs matched in the two adjacent video frames. If the number of feature pairs determined based on the two adjacent video frames is less than a predetermined number of parade values, it may be that the video has undergone a transition, in which case it may be possible not to use the alignment process. A 3D point cloud reconstruction can be performed on the depth view of the video frame to be-processed to determine the 3D feature pairs corresponding to the 2D feature pairs in the two neighboring video frames. The number of groups of 2D feature point pairs in the two adjacent video frames comprises at least one, and correspondingly, the number of groups of 3D feature point pairs comprises at least one group. The at least one set of 3D feature point pairs may be determined as a point pair in a collection of 3D feature point pairs. Optionally, the number of groups of the at least one set of 3D feature point pairs is 8.

As an example, two adjacent video frames are represented by t and t-1. A feature point in frame t and frame t−1 can be determined based on a feature point processing algorithm, and a one-to-one pair of feature points (2D feature point pair) can be obtained based on a feature point matching algorithm. A feature point pair is a different projection of the same point on t-frame and t−1 frame. The t-frame and t−1-frame are reconstructed into a 3D point cloud with a to-be-processed depth view, and the corresponding positions of the 2D feature point pairs in the 3D point cloud are determined to obtain the 3D feature point pairs. It can be understood that the number of 3D feature point pairs corresponds to the number of 2D feature point pairs.

S230. Determine a camera motion parameter of the two adjacent video frames based on the plurality of sets of 3D feature point pairs of the collection of 3D feature point pairs, and determine the camera motion parameter as a camera motion parameter of a preceding video frame among the two adjacent video frame.

In the present embodiment, based on the camera motion parameters, the processing on the plurality of 3D feature point pairs in the collection of 3D feature point pairs by the algorithm is determined, and the camera motion parameters can be obtained by solving the algorithm.

The camera motion parameter comprises a rotation matrix and a displacement matrix. The rotation matrix and displacement matrix characterize the movement of the camera in space when two adjacent video frames are captured. Based on the camera motion parameter, it can be determined that the point cloud in the two adjacent video frames can be processed without the 3D feature point pairs. The obtained camera motion parameters can be determined as the motion parameters of the preceding video frame in the adjacent video frame.

In an embodiment, a 3D feature point cloud in a collection of 3D feature point pairs of two adjacent video frames can be processed by adopting the RANSAC (Random Sample Consensus) algorithm, which can be solved to obtain the rotation matrix R and translation matrix T of the two adjacent video frames. The rotation matrix and translation matrix are determined as the camera motion parameters of the preceding video frame of the two adjacent video frames.

S240. Determine the target depth view of the plurality of video frames based on the to-be-processed depth view of the plurality of video frames and the corresponding camera motion parameter.

In the present embodiment, determining the target depth view of the plurality of video frames based on the to-be-processed depth view of the plurality of video frames and the corresponding camera motion parameter comprises: obtaining a to-be-used 3D point cloud of a current to-be-processed depth view for the to-be-processed depth view based on an original 3D point cloud, a rotation matrix and a translation matrix of the current to-be-processed depth view; and obtaining a target depth view corresponding to all video frames based on the original 3D point cloud, the to-be-used 3D point cloud, and a predetermined depth adjustment coefficient of the to-be-processed depth view.

In the present embodiment, the 3D point cloud directly reconstructed based on the to-be-processed depth view may be determined as the original 3D point cloud. The 3D point cloud obtained after the original 3D point cloud is processed by a rotation matrix and a translation matrix is determined as the to-be-used 3D point cloud. In other words, the original 3D point cloud is the uncorrected point cloud, and the to-be-used original 3D point cloud is the point cloud after the camera parameters are corrected. The predetermined depth adjustment coefficient can be understood as tuning coefficients, coefficients used to process the original 3D point cloud and the to-be-used 3D point cloud again, and the point cloud after being processed by the predetermined depth adjustment coefficient is more compatible with the video frame.

As an example, the rotation matrix in the camera motion parameters is represented by R, the translation matrix is represented by T, and the depth value in the to-be-processed depth view in the corrected t frame can be:

$$P = {P}^{′} * R + T$$

$${P}^{″} = {P}^{′} * ( 1 - a ) + P * a$$

$$D = {P}^{″} [ : , : , 2 ]$$

Herein, P′ is a point cloud before correction of t video frames, P″ is a point cloud after correction of t video frames, P is an intermediate value, D is a depth of the 3D point cloud of the corrected t video frames, and a is a preset depth adjustment factor.

It can be understood that processing the 3D point cloud of the video frame based on the camera motion parameters can obtain the relative depth value between two adjacent video frames. The problem that the depth value in the depth view to-be-processed is an absolute value, which leads to inaccurate image alignment, is solved, and the depth value of each respective pixel point in the video frame is implemented to be aligned. Thereby obtaining a video frame with relative depth values, which provides a reliability guarantee for the subsequent determination of a depth split line.

In an embodiment, after depth alignment is performed for each video frame to obtain a depth value for respective pixel point in each video frame, the to-be-processed depth view may be updated based on the depth value for each pixel point. Thereby a target depth view corresponding to each video frame is obtained, the target depth view being the view obtained after the depth alignment.

S250. Determine a split line depth value of at least one depth split line corresponding to the target video based on the target depth view.

In the present embodiment, before determining a split line depth value of at least one depth split line corresponding to the target video based on the target depth view, the method further comprises: determining a significant object in the plurality of video frames, and determining a to-be-processed mask map of a corresponding video frame based on the significant object, to determine the split line depth value based on the to-be-processed mask map of the plurality of video frames and the target depth view.

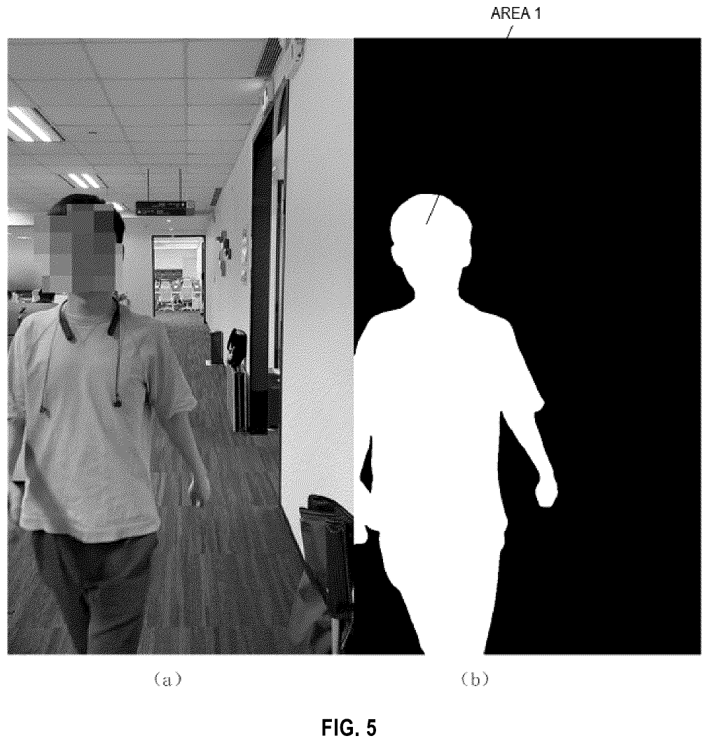

In the present embodiment, the concept of significant objects is derived from the user's study of the visual system. The first object in a plurality of video frames to be reflected to the user's eyes can be determined as a significant object, i.e., the object in the frame that is easy for the user to pay attention to at the first glance can be determined as a significant object. Significant objects generally have the characteristics of being in the center of the frame, having clear pixels, and having suitable depth. A neural network for salient object split can be pre-trained, and the neural network can be used to determine the significant objects in each video frame. neural network can be pre-trained to obtain the significant object split, and then based on this neural network, the significant objects in each respective video frame can be determined. After determining the significant objects, the pixel points corresponding to the significant objects may be set to a first predetermined pixel value, and the pixel points other than the significant objects in the video frame may be set to a second predetermined pixel value. As an example, the first predetermined pixel value may be 255, and the second predetermined pixel value may be 0. After determining the significant object in the current video frame based on the neural network, the color of the pixel point corresponding to the significant object may be set to white, and the color of the pixel point corresponding to the non-significant object may be set to black. The image obtained at this point is determined as a mask image to-be-processed, see FIG. 5, wherein (a) represents the video frame, (b) in FIG. 5 represents the to-be-processed mask image, and area 1 identifies the mask area of the significant object in the video frame. The to-be-processed mask image is the image obtained by setting the pixel points of the significant area in the video frame to white and the pixel points of the non-significant object to black. The depth split line can be understood as a front background split line. The split line depth value is used to determine the depth value of the corresponding pixel point.

In an embodiment, respective video frames of the target video are input into a pre-trained significant object splitting model to obtain a significant object in respective video frames. The pixel points corresponding to the significant objects are set to white, and the pixel points other than the significant objects are set to black, thereby obtaining a black-and-white schematic view comprising the profile of the significant objects, which is determined as a-bebe-processed mask map. Optionally, by means of the target depth view for respective video frame and the corresponding to-be-processed mask map, a split line depth value for at least one split line can be determined.

In the present embodiment, determining a split line depth value of at least one depth split line corresponding to the target video based on the target depth view comprises: determining an average depth value of a mask area in the to-be-processed mask map for the plurality of video frames, based on a to-be-processed mask map and a target depth view of a current video frame; and determining the split line depth value of at least one depth split line based on the average depth value of the plurality of video frames and a predetermined split line adjustment coefficient.

It should be noted that the existence of a 3D video view of a 2D video mainly utilizes the user's optical illusion. Therefore, a depth value of at least two depth split lines can be predetermined, and then a pixel value of a corresponding pixel point in the video frame can be adjusted based on the depth value, so as to achieve the effect of 3D display.

In the present embodiment, the area corresponding to the significant object in the to-be-processed mask map is determined as the mask area, i.e., the white area in the to-be-processed mask map is the mask area. The average depth value is the value obtained after processing the depth values of all pixel points in the mask area. The predetermined split line adjustment coefficient may be a coefficient pre-set based on experience. The coefficient may adjust the depth values of at least two depth split lines, thereby determining the pixel values of the corresponding pixel points to achieve the effect of 3D display.

Generally, if a significant object is highlighted on a display device, it is often interpreted as a three-dimensional effect display. Thus, a pixel point on at least one depth split line can be analyzed and processed in order to determine a target pixel value for the corresponding pixel point.

In an embodiment, in order to clearly introduce how the average depth value is determined, an example of determining the average depth value of one of the video frames may be introduced. A mask map and a target depth view of the current video frame are obtained, and a depth value of a pixel of the mask area in the-be-processed mask map in the target depth view is determined. The total depth value of the mask area is obtained by summing multiple depth values in the mask area. At the same time, the total depth value is obtained by summing the depth values of all pixels in the target depth view. The ratio between the total depth value and the total depth value of the mask area is calculated to obtain the average depth value of the current video frame. Based on this method, the average depth value of each respective video frame can be determined. After obtaining the average depth value of each video frame, the average depth value is processed based on a predetermined split line adjustment coefficient to obtain the split line depth value of at least one split line.

In the present embodiment, determining an average depth value for each respective video frame, may be: in the presence of a to-be-processed mask map corresponding to the current video frame, a to-be-processed depth value of a plurality of to-be-processed pixel points in the mask area in the target depth view may be determined; based on the to-be-processed depth value and the plurality of to-be-processed depth values of the plurality of to-be-displayed pixel points in the target depth view, an average depth value of the mask area is determined. Correspondingly, in the absence of a to-be-processed mask map corresponding to the current video frame, an average depth value of the current video frame may be determined based on the average depth value of the plurality of recorded video frames.

It can be understood that if the current video frame comprises a significant object, then there is a mask map corresponding to the significant object to be-processed, and the average depth value corresponding to the mask area can be determined in the above manner. If the current video frame does not comprise a significant object, instead of calculating the average depth value of the current video frame based on the target depth view and the to-be-processed mask map, the average depth values of all video frames can be recorded, and the largest depth value among all average depth values is determined as the average depth value of the current video frame.

Based on the above embodiment, after determining an average depth value of the plurality of video frames, the method further comprises: determining a maximum value and a minimum value of the average depth value based on the average depth values corresponding to the plurality of video frames; determining a split line depth value of the at least one depth split line based on the minimum value, the split line adjustment factor, and the maximum value.

In the present embodiment, if the number of video frames comprises N, then the average depth value of a plurality of video frames in the target video frame may be represented by a vector of order 1×N, and the value in the vector represents the average depth value corresponding to the video frame. The split line adjustment coefficient is used to determine a final depth value of the depth split line, and the finalized depth value is determined as the split line depth value.

In an embodiment, based on the average depth value in respective video frame, a maximum depth value and a minimum depth value are selected. At the same time, based on the predetermined split line depth value, a maximum depth value and a minimum depth value are selected.

On the basis of the above embodiment, the number of depth split lines comprises two, then a split line depth value for determining the two depth split lines may be: At least one depth split line comprises a first depth split line and a second depth split line, based on the minimum value, the first split line adjustment coefficient, the first split line adjustment coefficient, the second split line adjustment coefficient, and the maximum value, determining a first split line depth value for the first depth split line, and a second split line depth value for the second depth split line.

As an example, assume that the respective to-be-processed mask map corresponding to the respective video frame is represented as: {sᵢ|i=1, 2, . . . , N}, and the target depth view is represented as: {dᵢ|i=1, 2, . . . , N}; wherein the Nth video frame in the i target video frame is a total of N video frames. If there is a significant object in the video frame, the depth value of the mask area can be determined by adopting the function expression Σdᵢ/Σmaskᵢ corresponding to if Σmaskᵢ=>0 in the following formula, where maski is the depth value corresponding to the pixel point used to characterize the significant object in the target depth view. If there is no significant object in the video frame, then determining the depth value of the mask area may be performed by adopting the function expression max depth corresponding to else in the following formula, i.e., the maximum depth value of the mask area in a plurality of video frames. In this way, the depth value of the mask area of respective video frame, i.e., the depth value of the significant object, can be obtained. If the first split line adjustment coefficient and the second split line adjustment coefficient are a¹ and a², respectively. determination of the first split line depth value and the second split line depth value can be: ref_depth₁=dₘᵢₙ+a¹*dₘₐₓ−dₘᵢₙ); ref_depth₂=dₘᵢₙ+a²*(dₘₐₓ−dₘᵢₙ), wherein ref_depth1 represents the first split line depth value and ref_depth2 represents the second split line depth value, dmax represents the maximum average depth value in all video frames and dmin represents the minimum average depth value in all video frames. By adopting the formula, the depth values of the two split lines can be determined, and if the depth split lines are distributed left and right, the first split line depth value can generally be determined as the split line depth value on the left, and the second split line depth value can be determined as the split line depth value most on the right.

It should be noted that the above method of determining the split line depth value can calculate the split line depth value based on the dynamic change process of the depth of the salient object in the whole video, and at the same time, it takes into account the anomaly processing when there is no significant object in the video, so it has stronger robustness. The values of a¹ and a² can be set to 0.3 and 0.7 respectively.

S260. For the target depth view, determine a target depth split line corresponding to a current pixel point of a current target depth view, and determine a target pixel value of the current pixel point based on a pixel depth value of the current pixel point and a split line depth value of the target depth split line.

S270. Determine a three-dimensional displaying video frame of the plurality of video frames of the target video based on target pixel values of a plurality of pixels in the target depth view.

In embodiments of the present disclosure, after determining the width and position of the depth split line, a to-be-processed depth view of respective video frames and 3D feature point pairs of two adjacent video frames can be determined. Based on the 3D feature point pairs, the camera motion parameters between the two adjacent video frames can be determined, and based on the camera motion parameters, the 3D point cloud corresponding to respective video frame and the corresponding depth value can be determined, i.e., after the to-be-processed depth view has been aligned, the relative depth view corresponding to respective video frame, i.e., the target depth view, can be obtained. Based on the target depth view and the to-be-processed mask map of respective video frames, an average depth value of a significant object area of each video frame can be determined, based on the average depth value to a split line depth value of the target video. The method solves the problem of relying on a 3D display device for three-dimensional display in the related technology and the problem of high cost, and implements a technical effect of determining a target pixel value of a corresponding pixel based on a depth value and a split line depth value of respective pixels in a plurality of video frames, and then implementing a three-dimensional displaying video frame based on the target pixel value.

### Embodiment Three

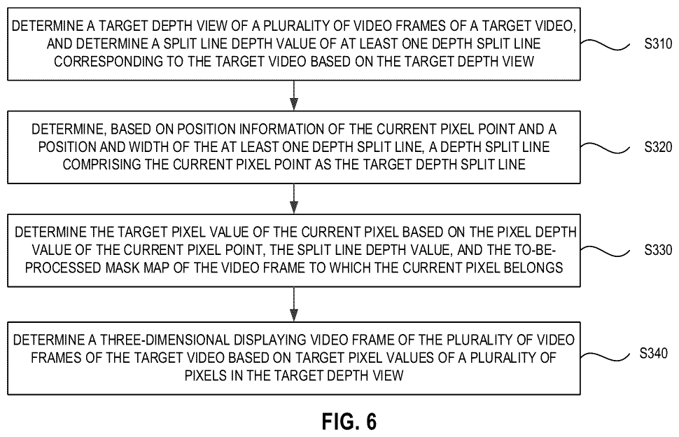

FIG. 6 shows a schematic flowchart of a method of video image processing provided by embodiment 3 of the present disclosure. On the basis of the foregoing embodiments, it is possible to make changes to the determination of the target depth split line and the determination of the target display information, the specific implementation of which can be found in the description of the present embodiments, wherein the technical terms that are the same as or corresponding to the above embodiments are not repeated herein.

As shown in FIG. 6, the method comprises:

S310. Determine a target depth view of a plurality of video frames of a target video, and determine a split line depth value of at least one depth split line corresponding to the target video based on the target depth view.

S320. Determine, based on position information of the current pixel point and a position and width of the at least one depth split line, a depth split line comprising the current pixel point as the target depth split line.

In the present embodiment, the location information may be the horizontal and vertical coordinates of the pixel point in the image. The position of the depth split line may be the position information of the depth split line in the target video. The width may be the width of the screen occupied by the depth split line, i.e., a plurality of pixel points exist within the position and width.

In an embodiment, if the number of depth split lines comprises one, it is possible to determine whether or not the current pixel is on the split line based on the position information of the current pixel, and based on the determination that the pixel is on the split line, the depth split line can be determined as the target depth split line. If the number of depth split lines comprises two, then based on the position information of the current pixel and the position and width of each depth split line, the depth split line on which the current pixel is located is determined, and the depth split line on which the current pixel is located is determined as the target depth split line.

S330. Determine the target pixel value of the current pixel based on the pixel depth value of the current pixel point, the split line depth value, and the to-be-processed mask map of the video frame to which the current pixel belongs.

Optionally, in accordance with a determination that a pixel depth value of the current pixel point is lower than the split line depth value, and that the current pixel point is located in a mask area of the to-be-processed mask map, maintaining an original pixel value of the current pixel point, and determining the original pixel value as the target pixel value; and in accordance with a determination that the pixel depth value of the current pixel point is greater than the split line depth value, and that the current pixel point is located in a mask area of the to-be-processed mask map, adjusting the original pixel value of the current pixel point to a first predetermined pixel value, and determining the first predetermined pixel value as the target pixel value of the current pixel point.

In the present embodiment, a depth value of a current pixel point may be determined based on a target depth view of the plurality of video frames, and this depth value is determined as a pixel depth value. The original pixel value is the pixel value of the pixel point at the time of collecting respective video frames.

In an embodiment, in accordance with a determination that a pixel depth value of the current pixel point is lower than a split line depth value of the target depth split line, determining whether or not the current pixel point is a pixel point on the significant object, and based on the determination that the current pixel point is a pixel point on the significant object, indicating that it is necessary to highlight the current pixel point in order to obtain the corresponding three-dimensional display effect. The pixel value of the current pixel point can be maintained unchanged. In accordance with a determination that the pixel depth value of the current pixel point is greater than the target depth split line, it means that the pixel is farther away from the camera device, and at the same time, it can be determined that the pixel is located in the mask area, and the original pixel value of the current pixel can be set to the first predetermined pixel value, which is optionally 0, or set to 255.

Optionally, in the absence of a target depth split line corresponding to the current pixel point, the original pixel value of the current pixel point may be determined as the target pixel value.

It is also noted that in case the current pixel point is not on a depth split line, the original pixel value of the pixel point is maintained unchanged.

S340. Determine a three-dimensional displaying video frame of the plurality of video frames of the target video based on target pixel values of a plurality of pixels in the target depth view.

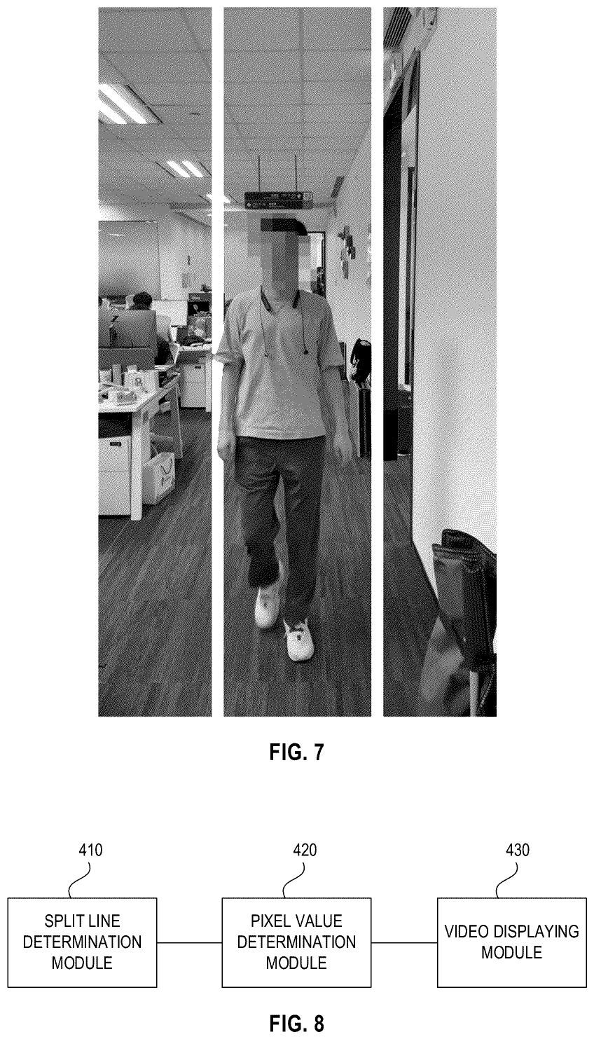

In an embodiment, based on the depth value of respective pixel point in the target depth view and the split line depth value of the corresponding split line, a target pixel value of a plurality of pixel points in the video frame can be determined, and based on the target pixel value of the plurality of pixel points, a three-dimensional displaying video frame of the target video frame can be obtained. The effect of the three-dimensional displaying video frame of one of the video frames can be referred to in FIG. 7. Certainly, the depth split line can be removed when actually displaying the video frame, and this is only a schematic diagram. Based on FIG. 7, we can see that this video frame corresponds to a three-dimensional displaying video frame.

In embodiments of the present disclosure, by determining a depth value of a split line between respective pixel point and a corresponding depth split line in a target video, determining a target pixel value of respective pixel point, and displaying respective pixel point based on the target pixel value, a technical effect of three-dimensional display is achieved, and a technical problem that a three-dimensional display device has to be used for three-dimensional display is solved in the related technology.

### Embodiment IV

FIG. 8 shows a structural schematic diagram of an apparatus for video image processing provided by embodiment 4 of the present disclosure. As shown in FIG. 8, the apparatus comprises: a split line determination module 410, a pixel value determination module 420 and a video displaying module 430.

Herein, a split line determination module 410 configured to determine a target depth view of a plurality of video frames of a target video, and determine a split line depth value of at least one depth split line corresponding to the target video based on the target depth view; a pixel value determination module 420 configured to, for the target depth view, determine a target depth split line corresponding to a current pixel point of a current target depth view, and determine a target pixel value of the current pixel point based on a pixel depth value of the current pixel point and a split line depth value of the target depth split line; and a video displaying module 430 configured to determine a three-dimensional displaying video frame of the plurality of video frames of the target video based on target pixel values of a plurality of pixels in the target depth view.

Based on the above technical solutions, the apparatus further comprises:
a video receiving module configured to receive the target video;
a split line setting module configured to set at least one depth split line corresponding to the target video, and determine a position and width of the at least one depth split line in the target video based on a display parameter of the target video; and wherein the display parameter is a display length and a display width of the target video displayed on a display interface.

Based on the above technical solutions, the split line determination module comprises: a first information processing unit configured to determine a to-be-processed depth view and to-be-processed feature points of the plurality of video frames; a feature point pair determination unit configured to obtain a collection of 3D feature point pair set of two adjacent video frames by processing the to-be-processed feature points of the two adjacent video frames sequentially; wherein the collection of 3D feature point pairs comprises a plurality of sets of 3D feature point pairs; a motion parameter determination unit configured to determine a collection of 3D feature point pair set of two adjacent video frames by processing the to-be-processed feature points of the two adjacent video frames sequentially; wherein the collection of 3D feature point pairs comprises a plurality of sets of 3D feature point pairs; and a depth view determination unit configured to determine the target depth view of the plurality of video frames based on the to-be-processed depth view of the plurality of video frames and the corresponding camera motion parameter.

On the basis of each of the above-described technical solutions, the first information processing unit, is further configured to obtain the to-be-processed depth view of the plurality of video frames by performing a depth estimation on the plurality of video frames; and determinie the to-be-processed feature points of the plurality of video frames by processing the plurality of video frames based on a feature point detection algorithm.

On the basis of the above technical solutions, the feature point pair determination unit is further configured to obtain at least one set of 2D feature point pairs associated with the two adjacent video frames by matching the to-be-processed feature points of the two adjacent video frames sequentially based on a feature point matching algorithm; obtain an original 3D point cloud corresponding to a to-be-processed depth view and at least one set of 3D feature point pair corresponding to the at least one set of 2D feature point pair, by performing a 3D point cloud reconstruction to the to-be-processed depth view of the two adjacent video frames; and determine the collection of 3D feature point pairs of the two adjacent video frames based on the at least one set of 3D feature point pairs.

Based on the above technical solutions, the depth view determination unit is also configured to:
obtain a to-be-used 3D point cloud of a current to-be-processed depth view for the to-be-processed depth view based on an original 3D point cloud, a rotation matrix and a translation matrix of the current to-be-processed depth view; and obtain a target depth view corresponding to all video frames based on the original 3D point cloud, the to-be-used 3D point cloud, and a predetermined depth adjustment coefficient of the to-be-processed depth view.

On the basis of each of the above-described technical solutions, the apparatus further comprises: a mask image determination module configured to determine a significant object in the plurality of video frames, and determine a to-be-processed mask map of a corresponding video frame based on the significant object, to determine the split line depth value based on the to-be-processed mask map of the plurality of video frames and the target depth view.

On the basis of each of the above technical solutions, the split line determination module is configured to determine an average depth value of a mask area in the to-be-processed mask map for the plurality of video frames, based on a to-be-processed mask map and a target depth view of a current video frame; and determine the split line depth value of at least one depth split line based on the average depth value of the plurality of video frames and a predetermined split line adjustment coefficient.

On the basis of each of the above technical solutions, the split line determination module is configured to in presence of the to-be-processed mask map corresponding to the current video frame, determine to-be-processed depth values of a plurality of to-be-processed pixels of the mask area of the target depth view; and determine the average depth value of the mask area based on to-be-displayed depth values of a plurality of pixels and a plurality of to-be-processed depth values in the target depth view; or, in absence of the to-be-processed mask map corresponding to the current video frame, determine an average depth value of the current video frame based on a recorded average depth value for the plurality of video frames.

Based on the above technical solutions, the split line determination module is configured to determine a maximum and minimum value of the average depth value based on the average depth value of the plurality of video frames; and determine the split line depth value of at least one depth split line based on the minimum value, the split line adjustment coefficient, and the maximum value.

On the basis of the above technical solutions, the at least one depth split line comprises a first depth split line and a second depth split line, the predetermined split line adjustment coefficient comprises a first split line adjustment coefficient and a second split line adjustment coefficient, the split line determination module, split line depth value determination module are further configured to: determine a first split line depth value of the first depth split line and a second split line depth value of the second depth split line based on the minimum value, the first split line adjustment coefficient, the second split line adjustment coefficient, and the maximum value.

Based on the above technical solutions, the pixel value determination module is configured to determine, based on position information of the current pixel point and a position and width of the at least one depth split line, whether the current pixel point is located on the at least one depth split line; and in accordance with a determination that the current pixel point is located on the at least one depth split line, determine a depth split line comprised the current pixel point as the target depth split line.

Based on the above technical solutions, the pixel value determination module is configured to determine the target pixel value of the current pixel based on the pixel depth value of the current pixel point, the split line depth value, and the to-be-processed mask map of the video frame to which the current pixel belongs.

Based on the above technical solutions, the pixel value determination module is configured to in accordance with a determination that a pixel depth value of the current pixel point is lower than the split line depth value, and that the current pixel point is located in a mask area of the to-be-processed mask map, maintain an original pixel value of the current pixel point, and determine the original pixel value as the target pixel value; and in accordance with a determination that the pixel depth value of the current pixel point is greater than the split line depth value, and that the current pixel point is located in a mask area of the to-be-processed mask map, adjust the original pixel value of the current pixel point to a first predetermined pixel value, and determine the first predetermined pixel value as the target pixel value of the current pixel point.

The embodiments of the present disclosure obtain at least one depth split line corresponding to the target video by processing a target depth view of the plurality of video frames in the target video, which is determined as a front background split line of the plurality of video frames in the target video. Determining the target display information for respective pixel points in the video frame based on the at least one depth split line, and then obtaining the three-dimensional displaying video frame corresponding to the video frame based on the target display information, which solves the problems of high cost and poor applicability of three-dimensional display in the related technology that requires the use of three-dimensional display devices; implements the condition that under the condition of without using a three-dimensional displaying device, it is only necessary to process respective pixel point in a video frame based on at least one pre-determined depth split line to obtain a three-dimensional displaying video frame of the corresponding video frame, which improves the convenience of three-dimensional displaying and the technical effect of universality; improves the convenience and universality of three-dimensional display.

The video image processing apparatus provided by the embodiments of the present disclosure can perform the video image processing method provided by any of the embodiments of the present disclosure, the method comprises performing the corresponding functional modules and beneficial effects.

It is worth noting that the units and modules comprised in the above apparatus are only divided based on functional logic, but are not limited to the above division, as long as they are able to implement the corresponding functions; furthermore, the specific names of the functional units are only for the purpose of facilitating differentiation, and are not intended to limit the scope of protection of the embodiments of the present disclosure.

### Embodiment V

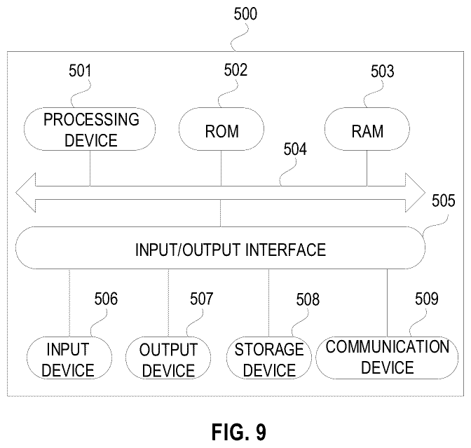

FIG. 9 shows a structural schematic diagram of an electronic device provided by embodiment 5 of the present disclosure. Referring to FIG. 9, a schematic diagram of a structure of an electronic device (e.g., a terminal device or a server in FIG. 9) 500 suitable for use in implementing embodiments of the present disclosure is shown. The terminal device in embodiments of the present disclosure may comprise an electronic device such as a cell phone, a laptop computer, a digital broadcast receiver, a Personal Digital Assistant (PDA), a Portable Android Device (PAD), a Portable Media Player (PMP), an in-vehicle terminal (e.g., an in-vehicle navigation terminal), and the like, and fixed terminals such as a digital television (TV), a desktop computer, and the like.

As shown in FIG. 9, the electronic device 500 may comprise a processing device (e.g., a central processor, a graphics processor, etc.) 501, which may perform a variety of appropriate actions and processes based on a program stored in Read-Only Memory (ROM) 502 or loaded from the storage device 508 into Random Access Memory (RAM) 503. The program is loaded from the storage device 508 into the Random Access Memory (RAM) 503 to perform various appropriate actions and processes. Various programs and data required for operation of the electronic device 500 are also stored in the RAM 503. The processing unit 501, the ROM 502, and the RAM 503 are connected to each other via the bus 504. An input/output (Input/Output, I/O) interface 505 is also connected to bus 504.

Generally, the following devices may be connected to the I/O interface 505: an input device 506 comprising, for example, a touch screen, a touch pad, a keyboard, a mouse, a video camera, a microphone, an accelerometer, a gyroscope, and the like; an output device 507 comprising, for example, a liquid crystal display (LCD), a speaker, a vibrator, and the like; a storage device 508 comprising, for example, a magnetic tape, a hard disk, and the like; and a communication device 509. The communication device 509 may allow the electronic device 500 to communicate wirelessly or wiredly with other devices to exchange data. Although FIG. 9 illustrates electronic device 500 with various devices, it should be understood that it is not required to implement or have all of the illustrated devices. More or fewer devices may alternatively be implemented or possessed.

In particular, according to embodiments of the present disclosure, the process described with reference to the flowchart above may be implemented as a computer software program. For example, embodiments of the present disclosure comprise a computer program product comprising a computer program hosted on a non-transitory computer-readable medium, the computer program comprising program code for executing the method shown in the flowchart. In such embodiments, the computer program may be downloaded and installed from a network via a communication device 509, or from a storage device 508, or from a ROM 502. When the computer program is executed by the processing device 501, the above functions defined in the method of the embodiments of the present disclosure are performed.

The names of the messages or information interacted between the plurality of devices in the presently disclosed embodiments are for illustrative purposes only, and are not intended to limit the scope of such messages or information.

The electronic device provided in the embodiments of the present disclosure belongs to the same concept as the video image processing method provided in the above embodiments, and technical details not described in detail in the present embodiments can be found in the above embodiments, and the present embodiments have the same beneficial effects as the above embodiments.

### Embodiment VI

Embodiments of the present disclosure provides a storage medium comprising computer-executable instructions, the computer-executable instructions, when executed by a computer processor, performing the method of video image processing provided by the above embodiment.

It is noted that the computer-readable medium described above in the present disclosure may be a computer-readable signal medium or a computer-readable storage medium or any combination thereof. The computer-readable storage medium may, for example, be a system, device, or apparatus or device of electricity, magnetism, light, electromagnetism, infrared, or semiconductors, or an electrical connection of any one or more wires, or a combination of the above. The computer-readable storage medium may comprise: portable computer disk, hard disk, random access memory (RAM), read-only memory (ROM), erasable programmable read-only memory (Erasable Programmable Read-Only Memory, EPROM, or flash memory), optical fiber, portable compact disk read-only memory (Compact Disc Read-Only Memory, CD-ROM, optical storage device, magnetic storage device, or any suitable combination of the foregoing. For purposes of the present disclosure, a computer-readable storage medium may be any tangible medium that contains or stores a program that may be used by or in combination with an instruction execution system, apparatus, or component.

And in the present disclosure, a computer-readable signal medium may comprise a data signal propagated in a baseband or as part of a carrier carrying computer-readable program code. Such propagated data signals may take a variety of forms, comprising electromagnetic signals, optical signals, or any suitable combination of the foregoing. The computer-readable signal medium may also be any computer-readable medium other than a computer-readable storage medium that sends, disseminates, or transmits a program for use by, or in conjunction with, an instruction-executing system, apparatus, or component. The program code contained on the computer-readable medium may be transmitted using any suitable medium, comprising: wire, fiber optic cable, radio frequency (RF), etc., or any suitable combination thereof.

In some implementations, clients, servers may communicate with any currently known or future developed network protocol such as HyperText Transfer Protocol (HTTP), and may be interconnected with any form or medium of digital data communication (e.g., a communications network). Examples of communication networks comprise Local Area Networks (LAN), Wide Area Networks (WAN), Internet (e.g., the Internet), and End-to-End Networks (e.g., ad hoc End-to-End Networks), as well as any currently known or future developed networks.

The computer-readable medium may be included in the above-mentioned electronic device; it may also exist separately and not be assembled into the electronic device.

The computer-readable medium carries one or more programs that, when the one or more programs are executed by the electronic device, enable the electronic device:
determining a target depth view of a plurality of video frames of a target video, and determining a split line depth value of at least one depth split line corresponding to the target video based on the target depth view;
for the target depth view, determining a target depth split line corresponding to a current pixel point of a current target depth view, and determining a target pixel value of the current pixel point based on a pixel depth value of the current pixel point and a split line depth value of the target depth split line; and
determining a three-dimensional displaying video frame of the plurality of video frames of the target video based on target pixel values of a plurality of pixels in the target depth view.

Computer program code for performing the operations of the present disclosure may be written in one or more programming languages, or combinations thereof, including object-oriented programming languages such as Java, Smalltalk, C++, conventional procedural programming languages such as the “C” language, or similar programming languages. or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer over any kind of network, including a LAN or WAN, or it may be connected to an external computer (e.g., via an Internet connection using an Internet service provider).

The flowcharts and block diagrams in the accompanying drawings illustrate the architecture, functionality, and operation of systems, methods, and computer program products that may be implemented in accordance with various embodiments of the present disclosure. At this point, respective box in the flowcharts or block diagrams may represent a module, program segment, or portion of code that contains one or more executable instructions for implementing a specified logical function. It should also be noted that in some implementations that are determined to be substitutions, the functions indicated in the boxes may also occur in a different order than that indicated in the accompanying drawings. For example, two consecutively represented boxes may actually be executed substantially in parallel, and they may sometimes be executed in reverse order, depending on the function involved. It should also be noted that respective of the boxes in the block diagrams and I or flowcharts, as well as combinations of the boxes in the block diagrams and I or flowcharts, may be implemented in a dedicated hardware-based system that performs the specified function or operation, or may be implemented in a combination of dedicated hardware and computer instructions.

Units described as being involved in embodiments of the present disclosure may be implemented by way of software or may be implemented by way of hardware. Wherein the name of a unit does not in some cases constitute a limitation of the unit itself, for example, a first obtaining unit may also be described as “a unit for obtaining at least two Internet Protocol addresses”.

The functions described above herein may be performed, at least in part, by one or more hardware logic components. For example, exemplary types of hardware logic components that may be used include: Field Programmable Gate Array (FPGA), Application Specific Integrated Circuit (ASIC), Application Specific Standard Parts (ASSP), System on Chip (SOC), and System on Chip (SOC). Application Specific Standard Parts (ASSP), System on Chip (System on Chip, SOC), Complex Programmable Logic Device (Complex Programmable logic device CPLD) and so on.

In the context of the present disclosure, a machine-readable medium may be a tangible medium that may include or store a program for use by or in conjunction with an instruction execution system, device, or apparatus. The machine-readable medium may be a machine-readable signal medium or a machine-readable storage medium. The machine-readable medium may comprise an electronic, magnetic, optical, electromagnetic, infrared, or semiconductor system, device, or apparatus, or any suitable combination thereof. Machine-readable storage media may comprise an electrical connection based on one or more wires, a portable computer disk, a hard disk, a random access memory (RAM), a read-only memory (ROM), an erasable programmable read-only memory (EPROM or flash memory), a fiber optic, a compact disk-read-only memory (CD-ROM) for convenience, an optical storage device, a magnetic storage device, or any suitable combination of the foregoing. or any suitable combination thereof.

According to one or more embodiments of the present disclosure, [Example 1] provides a method of video image processing, comprising:
determining a target depth view of a plurality of video frames of a target video, and determining a split line depth value of at least one depth split line corresponding to the target video based on the target depth view;
for the target depth view, determining a target depth split line corresponding to a current pixel point of a current target depth view, and determining a target pixel value of the current pixel point based on a pixel depth value of the current pixel point and a split line depth value of the target depth split line; and
determining a three-dimensional displaying video frame of the plurality of video frames of the target video based on target pixel values of a plurality of pixels in the target depth view.

According to one or more embodiments of the present disclosure, [Example 2] provides a method of video image processing, the method comprising:
optionally, before determining a target depth view of a plurality of video frames of a target video, the method further comprising: receiving the target video; setting at least one depth split line corresponding to the target video, and determining a position and width of the at least one depth split line in the target video based on a display parameter of the target video.

According to one or more embodiments of the present disclosure, [Example 3] provides a method of video image processing, the method comprising:
optionally, determining a position and width of the at least one depth split line in the target video based on a display parameter of the target video; and wherein the display parameter is a display length and a display width of the target video displayed on a display interface.

According to one or more embodiments of the present disclosure, [Example 4] provides a method of video image processing, the method comprising:
optionally, determining a target depth view of a plurality of video frames of a target video comprising: determining a to-be-processed depth view and to-be-processed feature points of the plurality of video frames; obtaining a collection of 3D feature point pair set of two adjacent video frames by processing the to-be-processed feature points of the two adjacent video frames sequentially; wherein the collection of 3D feature point pairs comprising a plurality of sets of 3D feature point pairs; determining a camera motion parameter of the two adjacent video frames based on the plurality of sets of 3D feature point pairs of the collection of 3D feature point pairs, and determining the camera motion parameter as a camera motion parameter of a preceding video frame among the two adjacent video frames; wherein the camera motion parameter comprising a rotation matrix and a displacement matrix; and determining the target depth view of the plurality of video frames based on the to-be-processed depth view of the plurality of video frames and the corresponding camera motion parameter.

According to one or more embodiments of the present disclosure, [Example 5] provides a method of video image processing, the method comprising:
optionally, determining a to-be-processed depth view and to-be-processed feature points of the plurality of video frames comprising: obtaining the to-be-processed depth view of the plurality of video frames by performing a depth estimation on the plurality of video frames; and determining the to-be-processed feature points of the plurality of video frames by processing the plurality of video frames based on a feature point detection algorithm.

According to one or more embodiments of the present disclosure, [Example 6] provides a method of video image processing, the method comprising:
optionally, obtaining a collection of 3D feature point pairs of two adjacent video frames by processing the to-be-processed feature points of the two adjacent video frames sequentially comprising: obtaining at least one set of 2D feature point pairs associated with the two adjacent video frames by matching the to-be-processed feature points of the two adjacent video frames sequentially based on a feature point matching algorithm; obtaining an original 3D point cloud corresponding to a to-be-processed depth view and at least one set of 3D feature point pair corresponding to the at least one set of 2D feature point pair, by performing a 3D point cloud reconstruction to the to-be-processed depth view of the two adjacent video frames; and determining the collection of 3D feature point pairs of the two adjacent video frames based on the at least one set of 3D feature point pairs.

According to one or more embodiments of the present disclosure, [Example 7] provides a method of video image processing, the method comprising:
optionally, determining a camera motion parameter of the two adjacent video frames based on the plurality of sets of 3D feature point pairs of the collection of 3D feature point pairs, and determining the camera motion parameter as a camera motion parameter of a preceding video frame among the two adjacent video frames, comprising: obtaining, by processing the position information of each 3D feature point pair in the collection of the plurality of 3D feature point pairs, a rotation matrix and a displacement matrix in the camera motion parameter, and using the rotation matrix and the displacement matrix as the camera motion parameter for the preceding video frame of the two adjacent video frames.

According to one or more embodiments of the present disclosure, [Example 8] provides a method of video image processing, the method comprising:
optionally, determining the target depth view of the plurality of video frames based on the to-be-processed depth view of the plurality of video frames and the corresponding camera motion parameter comprising: obtaining a to-be-used 3D point cloud of a current to-be-processed depth view for the to-be-processed depth view based on an original 3D point cloud, a camera motion parameter of the current to-be-processed depth view; and obtaining a target depth view corresponding to all video frames based on the original 3D point cloud, the to-be-used 3D point cloud, and a predetermined depth adjustment coefficient of the to-be-processed depth view.

According to one or more embodiments of the present disclosure, [Example 9] provides a method of video image processing, the method comprising:
optionally, before determining a split line depth value of at least one depth split line corresponding to the target video based on the target depth view, the method further comprising: determining a significant object in the plurality of video frames, and determining a to-be-processed mask map of a corresponding video frame based on the significant object, to determine the split line depth value based on the to-be-processed mask map of the plurality of video frames and the target depth view.

According to one or more embodiments of the present disclosure, [Example 10] provides a method of video image processing, the method comprising:
optionally, determining a split line depth value of at least one depth split line corresponding to the target video based on the target depth view comprising: determining an average depth value of a mask area in the to-be-processed mask map for the plurality of video frames, based on a to-be-processed mask map and a target depth view of a current video frame; and determining the split line depth value of at least one depth split line based on the average depth value of the plurality of video frames and a predetermined split line adjustment coefficient.

According to one or more embodiments of the present disclosure, [Example 11] provides a method of video image processing, the method comprising:
optionally, determining an average depth value of a mask area in the to-be-processed mask map based on a to-be-processed mask map and a target depth view of a current video frame comprising: in presence of the to-be-processed mask map corresponding to the current video frame, determining to-be-processed depth values of a plurality of to-be-processed pixels of the mask area of the target depth view; and determining the average depth value of the mask area based on to-be-displayed depth values of a plurality of pixels and a plurality of to-be-processed depth values in the target depth view.

According to one or more embodiments of the present disclosure, [Example 12] provides a method of video image processing, the method comprising:
optionally, determining an average depth value of a mask area in the to-be-processed mask map based on a to-be-processed mask map and a target depth view of a current video frame comprising: in absence of the to-be-processed mask map corresponding to the current video frame, determining an average depth value of the current video frame based on a recorded average depth value for the plurality of video frames.

According to one or more embodiments of the present disclosure, [Example 13] provides a method of video image processing, the method comprising:
optionally, determining the split line depth value of at least one depth split line based on the average depth value of the plurality of video frames and a predetermined split line adjustment coefficient comprising: determining a maximum and minimum value of the average depth value based on the average depth value of the plurality of video frames; and determining the split line depth value of at least one depth split line based on the minimum value, the split line adjustment coefficient, and the maximum value.

According to one or more embodiments of the present disclosure, [Example 14] provides a method of video image processing, the method comprising:
optionally, the at least one depth split line comprises a first depth split line and a second depth split line, the predetermined split line adjustment coefficient comprises a first split line adjustment coefficient and a second split line adjustment coefficient, and determining the split line depth value of at least one depth split line based on the minimum value, the split line adjustment coefficient, and the maximum value comprising: determining a first split line depth value of the first depth split line and a second split line depth value of the second depth split line based on the minimum value, the first split line adjustment coefficient, the second split line adjustment coefficient, and the maximum value.

According to one or more embodiments of the present disclosure, [Example 15] provides a method of video image processing, the method comprising:
optionally, determining a target depth split line corresponding to a current pixel point of a current target depth view comprising: determining, based on position information of the current pixel point and a position and width of the at least one depth split line, whether the current pixel point is located on the at least one depth split line; and in accordance with a determination that the current pixel point is located on the at least one depth split line, determining a depth split line comprised the current pixel point as the target depth split line.

According to one or more embodiments of the present disclosure, [Example 16] provides a method of video image processing, the method comprising:
optionally, determining a target pixel value of the current pixel point based on a pixel depth value of the current pixel point and a split line depth value of the target depth split line comprising: determining the target pixel value of the current pixel based on the pixel depth value of the current pixel point, the split line depth value, and the to-be-processed mask map of the video frame to which the current pixel belongs.

According to one or more embodiments of the present disclosure, [Example 17] provides a method of video image processing, the method comprising:
optionally, determining the target pixel value of the current pixel based on the pixel depth value of the current pixel point, the split line depth value, and the to-be-processed mask map of the video frame to which the current pixel belongs comprising: in accordance with a determination that a pixel depth value of the current pixel point is lower than the split line depth value, and that the current pixel point is located in a mask area of the to-be-processed mask map, maintaining an original pixel value of the current pixel point, and determining the original pixel value as the target pixel value; and in accordance with a determination that the pixel depth value of the current pixel point is greater than the split line depth value, and that the current pixel point is located in a mask area of the to-be-processed mask map, adjusting the original pixel value of the current pixel point to a first predetermined pixel value, and determining the first predetermined pixel value as the target pixel value of the current pixel point.

According to one or more embodiments of the present disclosure, [Example 18] provides a method of video image processing, the method comprising:

Optionally, determining, if no target depth split line corresponding to the current pixel point exists, the original pixel value of the current pixel point as the target pixel value.

According to one or more embodiments of the present disclosure, [Example 19] provides an apparatus for video image processing, the apparatus comprising:
a split line determination module configured to determine a target depth view of a plurality of video frames of a target video, and determine a split line depth value of at least one depth split line corresponding to the target video based on the target depth view;
a pixel value determination module configured to, for the target depth view, determine a target depth split line corresponding to a current pixel point of a current target depth view, and determine a target pixel value of the current pixel point based on a pixel depth value of the current pixel point and a split line depth value of the target depth split line; and
a video displaying module configured to determine a three-dimensional displaying video frame of the plurality of video frames of the target video based on target pixel values of a plurality of pixels in the target depth view.

1. A method of video image processing, comprising:
determining a target depth view of a plurality of video frames of a target video, and determining a split line depth value of at least one depth split line corresponding to the target video based on the target depth view;
for the target depth view, determining a target depth split line corresponding to a current pixel point of a current target depth view, and determining a target pixel value of the current pixel point based on a pixel depth value of the current pixel point and a split line depth value of the target depth split line; and
determining a three-dimensional displaying video frame of the plurality of video frames of the target video based on target pixel values of a plurality of pixels in the target depth view.

2. The method of claim 1, further comprising, before determining a target depth view of a plurality of video frames of a target video:
receiving the target video;
setting at least one depth split line corresponding to the target video, and determining a position and width of the at least one depth split line in the target video based on a display parameter of the target video; and
wherein the display parameter is a display length and a display width of the target video displayed on a display interface.

3. The method of claim 1, wherein determining a target depth view of a plurality of video frames of a target video comprises:
determining a to-be-processed depth view and to-be-processed feature points of the plurality of video frames;
obtaining a collection of 3D feature point pair set of two adjacent video frames by processing the to-be-processed feature points of the two adjacent video frames sequentially; wherein the collection of 3D feature point pairs comprises a plurality of sets of 3D feature point pairs;
determining a camera motion parameter of the two adjacent video frames based on the plurality of sets of 3D feature point pairs of the collection of 3D feature point pairs, and determining the camera motion parameter as a camera motion parameter of a preceding video frame among the two adjacent video frames; wherein the camera motion parameter comprises a rotation matrix and a displacement matrix; and
determining the target depth view of the plurality of video frames based on the to-be-processed depth view of the plurality of video frames and the corresponding camera motion parameter.

4. The method of claim 3, wherein determining a to-be-processed depth view and to-be-processed feature points of the plurality of video frames comprises:
obtaining the to-be-processed depth view of the plurality of video frames by performing a depth estimation on the plurality of video frames; and
determining the to-be-processed feature points of the plurality of video frames by processing the plurality of video frames based on a feature point detection algorithm.

5. The method of claim 3, wherein obtaining a collection of 3D feature point pairs of two adjacent video frames by processing the to-be-processed feature points of the two adjacent video frames sequentially comprises:
obtaining at least one set of 2D feature point pairs associated with the two adjacent video frames by matching the to-be-processed feature points of the two adjacent video frames sequentially based on a feature point matching algorithm;
obtaining an original 3D point cloud corresponding to a to-be-processed depth view and at least one set of 3D feature point pair corresponding to the at least one set of 2D feature point pair, by performing a 3D point cloud reconstruction to the to-be-processed depth view of the two adjacent video frames; and
determining the collection of 3D feature point pairs of the two adjacent video frames based on the at least one set of 3D feature point pairs.

6. The method of claim 4, wherein determining the target depth view of the plurality of video frames based on the to-be-processed depth view of the plurality of video frames and the corresponding camera motion parameter comprises:
obtaining a to-be-used 3D point cloud of a current to-be-processed depth view for the to-be-processed depth view based on an original 3D point cloud, a rotation matrix, and a translation matrix of the current to-be-processed depth view; and
obtaining a target depth view corresponding to all video frames based on the original 3D point cloud, the to-be-used 3D point cloud, and a predetermined depth adjustment coefficient of the to-be-processed depth view.

7. The method of claim 1, further comprising, before determining a split line depth value of at least one depth split line corresponding to the target video based on the target depth view:
determining a significant object in the plurality of video frames, and determining a to-be-processed mask map of a corresponding video frame based on the significant object, to determine the split line depth value based on the to-be-processed mask map of the plurality of video frames and the target depth view.

8. The method of claim 7, wherein determining a split line depth value of at least one depth split line corresponding to the target video based on the target depth view comprises:
determining an average depth value of a mask area in the to-be-processed mask map for the plurality of video frames, based on a to-be-processed mask map and a target depth view of a current video frame; and
determining the split line depth value of at least one depth split line based on the average depth value of the plurality of video frames and a predetermined split line adjustment coefficient.

9. The method of claim 8, wherein determining an average depth value of a mask area in the to-be-processed mask map based on a to-be-processed mask map and a target depth view of a current video frame comprises:
in presence of the to-be-processed mask map corresponding to the current video frame, determining to-be-processed depth values of a plurality of to-be-processed pixels of the mask area of the target depth view; and
determining the average depth value of the mask area based on to-be-displayed depth values of a plurality of pixels and a plurality of to-be-processed depth values in the target depth view; or,
in absence of the to-be-processed mask map corresponding to the current video frame, determining an average depth value of the current video frame based on a recorded average depth value for the plurality of video frames.

10. The method of claim 8, wherein determining the split line depth value of at least one depth split line based on the average depth value of the plurality of video frames and a predetermined split line adjustment coefficient comprises:
determining a maximum and minimum value of the average depth value based on the average depth value of the plurality of video frames; and
determining the split line depth value of at least one depth split line based on the minimum value, the split line adjustment coefficient, and the maximum value.

11. The method of claim 10, wherein the at least one depth split line comprises a first depth split line and a second depth split line, the predetermined split line adjustment coefficient comprises a first split line adjustment coefficient and a second split line adjustment coefficient, and
determining the split line depth value of at least one depth split line based on the minimum value, the split line adjustment coefficient, and the maximum value comprises:
determining a first split line depth value of the first depth split line and a second split line depth value of the second depth split line based on the minimum value, the first split line adjustment coefficient, the second split line adjustment coefficient, and the maximum value.

12. The method of claim 1, wherein determining a target depth split line corresponding to a current pixel point of a current target depth view comprises:
determining, based on position information of the current pixel point and a position and width of the at least one depth split line, whether the current pixel point is located on the at least one depth split line; and
in accordance with a determination that the current pixel point is located on the at least one depth split line, determining a depth split line comprised the current pixel point as the target depth split line.

13. The method of claim 1, wherein determining a target pixel value of the current pixel point based on a pixel depth value of the current pixel point and a split line depth value of the target depth split line comprises:
determining the target pixel value of the current pixel based on the pixel depth value of the current pixel point, the split line depth value, and the to-be-processed mask map of the video frame to which the current pixel belongs.

14. The method of claim 13, wherein determining the target pixel value of the current pixel based on the pixel depth value of the current pixel point, the split line depth value, and the to-be-processed mask map of the video frame to which the current pixel belongs comprises:
in accordance with a determination that a pixel depth value of the current pixel point is lower than the split line depth value, and that the current pixel point is located in a mask area of the to-be-processed mask map, maintaining an original pixel value of the current pixel point, and determining the original pixel value as the target pixel value; and
in accordance with a determination that the pixel depth value of the current pixel point is greater than the split line depth value, and that the current pixel point is located in a mask area of the to-be-processed mask map, adjusting the original pixel value of the current pixel point to a first predetermined pixel value, and determining the first predetermined pixel value as the target pixel value of the current pixel point.

15-17. (canceled)

18. An electronic device, comprising:
a processor; and
a storage apparatus storing a program,
wherein the program, when executed by the processor, causes the processor to perform the method of video image processing comprising:
determining a target depth view of a plurality of video frames of a target video, and determining a split line depth value of at least one depth split line corresponding to the target video based on the target depth view;
for the target depth view, determining a target depth split line corresponding to a current pixel point of a current target depth view, and determining a target pixel value of the current pixel point based on a pixel depth value of the current pixel point and a split line depth value of the target depth split line; and
determining a three-dimensional displaying video frame of the plurality of video frames of the target video based on target pixel values of a plurality of pixels in the target depth view.

19. The electronic device of claim 18, wherein the method further comprises, before determining a target depth view of a plurality of video frames of a target video:
receiving the target video;
setting at least one depth split line corresponding to the target video, and determining a position and width of the at least one depth split line in the target video based on a display parameter of the target video; and
wherein the display parameter is a display length and a display width of the target video displayed on a display interface.

20. The electronic device of claim 18, wherein determining a target depth view of a plurality of video frames of a target video comprises:
determining a to-be-processed depth view and to-be-processed feature points of the plurality of video frames;
obtaining a collection of 3D feature point pair set of two adjacent video frames by processing the to-be-processed feature points of the two adjacent video frames sequentially; wherein the collection of 3D feature point pairs comprises a plurality of sets of 3D feature point pairs;
determining a camera motion parameter of the two adjacent video frames based on the plurality of sets of 3D feature point pairs of the collection of 3D feature point pairs, and determining the camera motion parameter as a camera motion parameter of a preceding video frame among the two adjacent video frames; wherein the camera motion parameter comprises a rotation matrix and a displacement matrix; and
determining the target depth view of the plurality of video frames based on the to-be-processed depth view of the plurality of video frames and the corresponding camera motion parameter.

21. The electronic device of claim 18, wherein determining a to-be-processed depth view and to-be-processed feature points of the plurality of video frames comprises:
obtaining the to-be-processed depth view of the plurality of video frames by performing a depth estimation on the plurality of video frames; and
determining the to-be-processed feature points of the plurality of video frames by processing the plurality of video frames based on a feature point detection algorithm.

22. The electronic device of claim 18, wherein obtaining a collection of 3D feature point pairs of two adjacent video frames by processing the to-be-processed feature points of the two adjacent video frames sequentially comprises:
obtaining at least one set of 2D feature point pairs associated with the two adjacent video frames by matching the to-be-processed feature points of the two adjacent video frames sequentially based on a feature point matching algorithm;
obtaining an original 3D point cloud corresponding to a to-be-processed depth view and at least one set of 3D feature point pair corresponding to the at least one set of 2D feature point pair, by performing a 3D point cloud reconstruction to the to-be-processed depth view of the two adjacent video frames; and
determining the collection of 3D feature point pairs of the two adjacent video frames based on the at least one set of 3D feature point pairs.

23. A non-transitory storage medium comprising computer-executable instructions, the computer-executable instructions, when executed by a computer processor, performing the method of video image processing comprising:
determining a target depth view of a plurality of video frames of a target video, and determining a split line depth value of at least one depth split line corresponding to the target video based on the target depth view;
for the target depth view, determining a target depth split line corresponding to a current pixel point of a current target depth view, and determining a target pixel value of the current pixel point based on a pixel depth value of the current pixel point and a split line depth value of the target depth split line; and
determining a three-dimensional displaying video frame of the plurality of video frames of the target video based on target pixel values of a plurality of pixels in the target depth view.
